(19) United States
(12) Patent Application Publication
(10) Pub. No.: US 2006/0060442 A1
(43) Pub. Date: Mar. 23, 2006

(54) One-way clutch

(75) Inventor: Kazuhiko Muramatsu, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-Warner K.K.

(21) Appl. No.: 11/183,890

(22) Filed: Jul. 19, 2005

(30) Foreign Application Priority Data
Jul. 21, 2004 (JP) 2004-212674

(51) Int. Cl. F16D 41/07

(52) U.S. Cl. 192/45.1

(57) ABSTRACT

There is provided a one-way clutch comprising an inner race and an outer face radially spaced from each other, arranged concentric with each other so as to be rotatable, relative to each other and having annular raceway surfaces, torque transmission members located between the inner race and the outer race, for transmitting a torque between the raceway surfaces, a cage for holding the torque members, equally in a circumferential direction, and an end bearing located between the inner race and the outer race, and closely fitted in the inner race for holding the inner race and the outer race, concentric with each other, characterized in that the cage is located in the end bearing, having an abutting part abutting against the inner peripheral surface of the end bearing so as to apply a frictional force to the end bearings.

### BACKGROUND OF THE INVENTION

1. Field of the Invention

The present invention relates to a one-way clutch used as a component which is incorporated in a drive unit of an automobile or the like so as to be used for transmission of a torque, back stop or the like, and in particular to an improvement in an end bearing in a one-way clutch.

2. Description of the Related Art

Heretofore, a one-way clutch used in a rotary portion of industrial machinery or the like, is held in such a way that an outer race or an inner race serving as a rotary member is exerted thereto with a certain dragging torque in order to prevent its function from being deteriorated by vibration and inertia.

For example, since abrupt acceleration and deceleration in rotation of the outer race causes a sprag to slip on an outer raceway due to its inertia, producing a friction, it is required to apply a frictional force, that is, a dragging torque between an outer cage and an outer race in order to carry out rotation always integral with the outer race. Thus, the motion of the outer race can be rapidly transmitted to the outer cage, and the motion of the sprag can be ensured.

In order to obtain the dragging torque as stated above, the outer cage of a conventional one-way clutch has been notched by a T-bar process or an I-bar process, or is attached thereto with an additional member such as a drag clip which is a spring member. Further, the above-mentioned conventional one-way clutch has caused problems as to workability, an increased number of necessary components, and the like, and accordingly, there have been proposed such measures that the outer cage has an elliptic flange part.

For example, Japanese Utility Model Laid-Open No. 60-127128 discloses such a configuration that the cage has a bearing surface which is notched in part or in its entirety, so as to form planar parts making contact with the annular inner surface of the outer race in order to obtain a required dragging torque from this planar part.

Further, Japanese Utility Model Laid-Open No. 62-188632 discloses a cage having a flange part which is elliptic so as to make contact with the annular inner surface of the outer race at both ends of the major axis thereof in order to obtain a required dragging torque.

Japanese Utility Model Laid-Open No. 05-54831 discloses such a configuration that a protrusion formed in a part of the cage and extending radially outward, makes contact with the annular inner surface of the outer race in order to obtain a required dragging torque.

However, the above-mentioned one-way clutches have raised the following problems:

In general, a one-way clutch used for a stator is provided therein with bushings made of, for example, bearing alloy such as Al alloy, which are arranged in parallel at both axially ends so as to be used as bearings for the inner and outer races. In this case, the overall axial length of the one-way clutch becomes, in general, longer due to the provision of the bushings. In order to avoid increasing the axial length of the one-way clutch, end bearings are used, instead of the bushings.

Each end bearing has flange parts which are axially extended from the inner and outer diameters of an annular plate member, and which exhibit a bearing function for the inner and outer race. Since the flange part of the cage is surrounded by the flange parts of the end bearings, the flange part of the cage cannot have such a configuration that the inner and outer races are directly applied thereto with a dragging torque therefrom.

### SUMMARY OF THE INVENTION

Thus, an object of the present invention is to provide a one-way clutch incorporating end bearings, which can exhibit a stable dragging torque and have a simple configuration with a shortened axial length.

To the end, according to the present invention, there is provided a one-way clutch comprising an inner race and an outer race arranged so as to be rotatable relative to each other and concentric with each other, and having annular raceway surfaces, torque transmission members located between the inner race and the outer race, for transmitting a torque between raceway surfaces of the outer race and the inner race, a cage for holding the toque transmission members, equally in a circumferential direction, and an end bearing located between the inner race and the outer race and closely fitted in the outer race, for holding the inner race and the outer race, concentric with each other.

characterized in that the cage is located in the end bearing, and is incorporated with an abutting part making contact with the inner peripheral surface of the end bearing so as to apply a frictional force to the end bearing.

According to the present invention, the following technical effects and advantages can be obtained:

There can be provided a one-way clutch such that since the abutting part provided in the cage abuts against the inner race or the outer race through the intermediary of the end bearing so that the cage is resiliently deformed, thereby it is possible to exhibit a dragging torque in a simple configuration with no risk of shortening the use life thereof. Since the abutting part has a simple structure, dimensional control can be facilitated and the machining therefor can be simplified. Due to the provision of only a protrusion on the flange part of the cage, there can be provided a one-way clutch at an inexpensive manufacturing cost with a longer service life without increasing processing steps and without lowering the strength thereof. It the flange parts of the cage are formed in a substantially circular shape or an elliptic shape from which it is deformed into an elliptic shape or a polygonal shape, or if the cage is formed in an elliptic shape in its entirety, the manufacture thereof can be further facilitated. With the above-mentioned configuration, there can be manufactured a one-way clutch having a short axial length.

Since the flange part of the cage is provided thereon with the protrusion projected radially outward, the tip end of the protrusion make a contact with the inner peripheral surface of the end bearing, and a part of the flange part of the cage facing the protrusion makes contact with the inner peripheral surface of the end bearing which has a perfect circular shape, and accordingly, the cage is resiliently deformed in a radial direction, thereby it is possible to obtain an appropriately frictional force between itself and the outer race through the intermediary of the end bearing closely fitted in the outer race.

### BRIEF DESCRIPTION OF THE DRAWINGS

FIG. 1 is a front view illustrating a one-way clutch in one embodiment of the present invention, a part of which is broken away;

FIG. 2 is an axially sectional view along a line 2-2 in FIG. 1;

FIG. 3 is an axially sectional view illustrating another example of an end bearing;

FIG. 4 is a graph for explaining a relationship between diameters of an outer race and an end bearing.

### DESCRIPTION OF THE PREFERRED EMBODIMENTS

Detailed explanation will be hereinbelow made of the present invention with reference the accompanying drawings. It is noted here that preferred embodiments of the present inventions will be hereinbelow explained. However, the technical scope of the present invention should not be limited to these embodiments. Further, like reference numerals are used to denote like parts throughout the drawings.

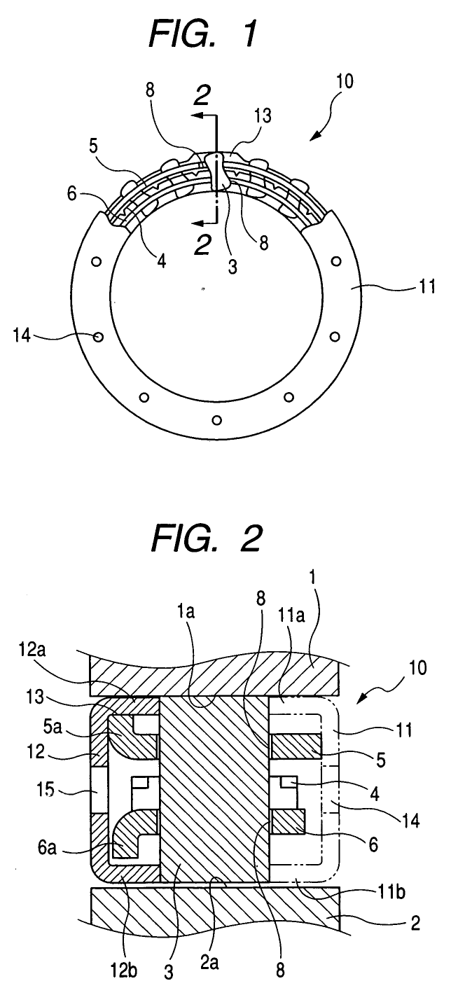

FIG. 1 is a partly broken front view which shows a one-way clutch 10 in an embodiment of the present invention, and FIG. 2 is an axially sectional view along line 2-2 in FIG. 1. In the one-way clutch in this embodiment, gourd-shaped sprags are used as torque transmission members. However, it is noted that the present invention may be also applied to any one-way clutch of another type. No outer race 1 and inner race 2 are shown in FIG. 1.

Referring to FIG. 2, the outer race 1 has an inner peripheral surface la which is substantially completely circular. Further, the inner race 2 has an inner peripheral surface 2a which is substantially completely circular. The outer race 1 and the inner race 2 are rotatable, relative to each other, the inner peripheral surfaces 1a and 1b being faced to each other.

In an annular space between the outer race 1 and the inner race 2, a plurality of gourd-shaped sprags 3 serving as torque transmission members for transmitting a torque between both races are arranged equally in the circumferential direction through which a torque is transmitted between the inner race and the outer race. The sprags 3 are held in substantially rectangular apertures 8 formed in a pair of cages, that is, an outer cage 5 and an inner cage 6. Bon springs 4 are arranged between the outer cage 5 and the inner cage 6 so as to apply a rise-up moment to the sprags 3 in a direction in which the sprags 3 are engaged with an engaging surface.

As clearly understood from FIG. 1, the annular inner cage 6 having a substantially complete circular bore, has an annular flange part 6a which is extended by a predetermined distance, substantially perpendicular at an axially one end part, that is, radially inward therefrom, the flange part 6a having a distal end part which faces the inner race 2 with a predetermined clearance therebetween.

Further, the annular outer cage 5 having a substantially completely circular bore has an annular flange part 5a which is extended by a predetermined distance at an axially one end part, that is, radially outward therefrom, the flange part 5a having the distal end part which faces the inner peripheral surface of an end bearing 12 with a predetermined clearance therebetween, excepts a protrusion 13.

Referring to FIG. 2 which is an axially sectional view along line 2-2 in FIG. 1, and which shows the one-way clutch 10 in detailed, in the one-way clutch 10, the substantially annular end bearings 11 and 12 are arranged between the inner race 2 and the outer race 1 at axially one end parts thereof, respectively. The end bearings 11 and 12 which are arranged between the inner race 2 and the outer race 1 so as to hold the inner race 2 and outer race 1, concentric with each other, serving as bearings for the inner and outer races.

The end bearings 11 and 12 are engaged with the inner peripheral surface 1a of the outer race 2, being secured thereto, that is, they are closely-fitted therein so as to be substantially stationary. That is, they are substantially integrally incorporated with the outer race 1. The end bearing 11 and/or the end bearing 12 incorporate flange parts 11a, 11b, and 12a, 12b which are extended axially inward from the outer diameter side and the inner diameter side thereof, respectively. Accordingly, they are closely fitted in the inner peripheral surface 1a of the outer race, at the outer peripheral surfaces of the flange parts 11b and 12b. Further, the outer peripheries of the flange parts 11b and 12b are opposed to the outer peripheral surface 2a of the inner race 2 with a predetermined clearance therebetween, so as to be slidable.

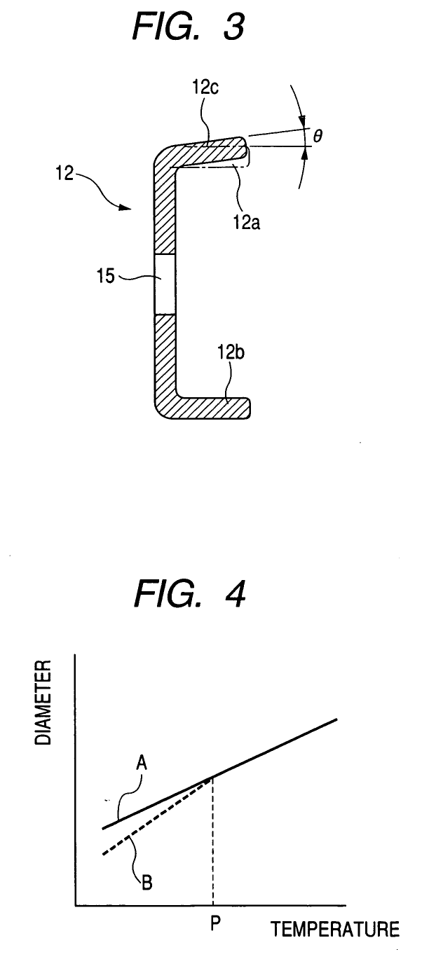

In addition to the above-mentioned statement, the end bearings can be fixed to the outer race 1 as follows. Referring to FIG. 3 which is an axially sectional view illustrating another example of the end bearing. The end bearing 12 incorporates a flange part 12c which is spread, radially outward at an angle θ in an initial condition. The outer diameter of the flange part 12c is larger than the inner diameter of the outer race 1.

While the flange part 12c is deformed toward the inner diameter side, the end bearing 12 is inserted in the inner peripheral surface of the outer race 1 by means of a spring force. After the insertion, the flange part 12c is deformed into a flange part 12a, similar to that shown in FIG. 1, and accordingly, the end bearing 12 is secured to the outer race 1 by a spring force by which the deformed flange part is restored toward the outer diameter side. It is noted that FIG. 3 shows the flange part which is largely widened toward the outer diameter side, for the sake of brevity for the explanation, but it is actually widened by a slight degree.

FIG. 4 shows a graph for explaining a relationship between diameters of the outer race 1 and the end bearings 11, 12. The outer race 1, for example, made of steel increases its diameter by thermal expansion with a grade as indicated by the solid line A. Further, the end bearings 11 and 12 made of, for example, copper, increase their diameters by thermal expansion with a grade as indicated by the broken line B.

At a lower temperature, a predetermined clearance is defined between the inner diameter of the outer race 1 and the outer diameters of the end bearings 11 and 12. During the operation of the one-way clutch, when the temperature is slightly increased, the outer diameters of the end bearings 11, 12 made of a material having a coefficient of thermal explanation which is larger than that of the outer race, become equal to the inner diameter of the outer race 1 at a temperature P. Thereafter, the inner diameter of the outer race 1 is equal to the outer diameter of the end bearings 11 and 12, and accordingly, the end bearings 11 and 12 are surely secured to the outer race 1.

That is, with the use of the thermal expansion, the outer diameter of the end bearing causes an interference with respect to the inner diameter of the outer race, and accordingly, the end bearings are surely secured to the outer race.

The end bearings 11 and 12 are formed therein with a plurality of through-holes 14 and 15 which are arranged equally in the circumferential direction, axially piercing. These through holes 14 and 16 serve as passages for feeing lubrication oil for lubricating the one-way clutch 10.

As shown in FIGS. 1 and 2, the flange part 5a of the outer cage 5 incorporates a protrusion 13 in a circumferential part thereof so that the protrusion 13 is arranged abutting against the inner peripheral surface of the end bearing 12. Since the flange part 5a of the outer cage 15 is surrounded by the flange part 12a of the end bearing 12, it cannot abut against the outer race 1. However, the end bearing 12 is closely fitted in the outer ring in a stationary condition, and accordingly, a required dragging torque is transmitted to the outre race 1 through the intermediary of the end bearing 12.

As stated above, the dragging torque with respect the outer race 1 is applied to the outer race 1 through the intermediary of the end bearing 12. Further, since the protrusion 13 formed on the flange part 5a of the outer cage 5 abuts against the inner peripheral surface of the end bearing 12 while a part of the flange part 5 which is opposite to the protrusion 13 at an about 180 deg. in the circumferential direction abuts against the inner peripheral surface of the end bearing 12, the outer cage 5 is resiliently deformed, resulting in the application of a dragging torque to the outer race 1.

Although two protrusions 13 are preferably provided, one or more of protrusions may be provided as necessary. Further, the annular flange part 5a of the outer cage 5 is formed in a polygonal shape substantially similar to a circle.

In the above-mentioned embodiment, with the provision of the protrusions 13 on the flange part 5a which is perfectly circular, since the protrusions 13 abut against the inner peripheral surface of the end bearing 12 with the use of resilient deformation of the cage, resulting in a pressing force acting on the outer race 1, and accordingly, a stable dragging force can be applied to the outer race. However, with no provision of the protrusions, the flange part 5a may be formed in an elliptic shape in its entirety, or the cage is formed into an elliptic shape in its entirety, and accordingly, the cage 5 abuts against the flange part 12a of the end bearing 12 at opposite ends of the major axis of the ellipse, for application of a dragging torque.

It is noted that explanation has been hereinabove made of such a configuration that the one-way clutch has two cages, that is, the outer cage and the inner cage, but it goes without saying that the present invention may be applied to a one-way clutch having a single cage.

This application claims priority from Japanese Patent Application No. 2004-212674 filed on July 21, 2004, which is hereby incorporated by reference herein.

What is claimed is:

1. A one-way clutch comprising an inner race and an outer face radially spaced from each other, arranged concentric with each other so as to be rotatable, relative to each other, and having annular raceway surfaces, torque transmission members located between the inner race and the outer race, for transmitting a torque between the raceway surfaces, a cage for holding the torque members, equally in a circumferential direction, and an end bearing located between the inner race and the outer race, and closely fitted in the outer race for holding the inner race and the outer race, concentric with each other,
characterized in that the cage is located in the end bearing, having an abutting part abutting against the inner peripheral surface of the end bearing so as to apply a frictional force to the end bearing.

2. A one-way clutch according to claim 1, characterized in that the abutting part is a protrusion which is extended radially outward from an outer periphery of the cage.

3. A one-way clutch according to claim 1, characterized in that the abutting part is a protrusion which is extended radially inward from an inner periphery of the cage.

4. A one-way clutch according to claim 1, characterized in that the flange part of the cage or the cage itself formed into an elliptic shape having a major axis at each of both ends of which the abutting part is arranged.

5. A one-way clutch according to claim 1, characterized in that the flange part of the cage or the cage itself formed into a circular shape which is deformed into a substantially polygonal shape, and the abutting part corresponds to each of at least two of apexes of the polygonal shape.

6. A one-way clutch according to claim 1, characterized in that the end bearings are made of a copper group material so as to be expanded at a temperature not lower than a predetermined value, by thermal expansion, so as to be fixed to the inner peripheral surface of the outer race.

7. A one-way clutch according to claim 1, characterized in that one of the end bearings has a flange part having an outer diameter larger than the inner diameter of the outer race, the flange part being deformed so as to be fixed to the outer race.

8. A one-way clutch according to claim 2, characterized in that one of the end bearings has a flange part having an outer diameter larger than the inner diameter of the outer race, the flange part being deformed so as to be fixed to the outer race.

9. A one-way clutch according to claim 3, characterized in that one of the end bearings has a flange part having an outer diameter larger than the inner diameter of the outer race, the flange part being deformed so as to be fixed to the outer race.

10. A one-way clutch according to claim 4, characterized in that one of the end bearings has a flange part having an outer diameter larger than the inner diameter of the outer race, the flange part being deformed so as to be fixed to the outer race.

11. A one-way clutch according to claim 5, characterized in that one of the end bearings has a flange part having an outer diameter larger than the inner diameter of the outer race, the flange part being deformed so as to be fixed to the outer race.

12. A one-way clutch according to claim 6, characterized in that one of the end bearings has a flange part having an outer diameter larger than the inner diameter of the outer race, the flange part being deformed so as to be fixed to the outer race.
